(19) United States
(12) Patent Application Publication
(10) Pub. No.: US 2007/0172750 A1
(43) Pub. Date: Jul. 26, 2007

(54) Toner for developing electrostatic latent image

(75) Inventor: Hiroto Kidokoro, CHIYODA-KU TOKYO JAPAN (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: ZEON CORPORATION, TOKYO JAPAN (JP)

(21) Appl. No.: 10/588,996

(22) PCT Filed: Feb. 18, 2005
(86) PCT No.: PCT/JP05/02557

§ 371 Date: Aug. 10, 2006

(30) Foreign Application Priority Data
Feb. 27, 2004 (JP) 2004-05264

(51) Int. Cl. G03G 9/08; G03G 9/087

(52) U.S. Cl. 430/108.4; 430/110.3; 430/111.4; 430/109.3; 430/108.1; 430/108.7

(57) ABSTRACT

A toner of the present containing a colored resin particle comprising a binder resin, a colorant, a charge control agent and a parting agent, has the following properties: (1) the colored resin particle has a volume average particle diameter (Dv) in the range of 4 to 9 μm; (2) the colored resin particle has an average sphericity in the range of 0.93 to 0.995; (3) the toner has a share viscosity (η1) in the range of 800 to 3,500 Pa·s at a temperature of 130° and a shear rate of 10/s; and (4) the toner has a share viscosity (η2) in the range of 100 to 1,000 Pa·s at a temperature of 130° and a shear rate of 500/s. The toner can be fixed at a low temperature even when the toner is used for a high-speed printing apparatus and has an excellent durability and shelf stability as well as an excellent hot-offset resistance.

### TECHNICAL FIELD

The present invention relates to a toner for developing electrostatic latent image, and in particular, to a toner for developing electrostatic latent image, which can be fixed at low temperatures even when the toner is used for a high-speed printing apparatus and has excellent durability and shelf stability as well as hot-offset resistance.

### BACKGROUND ART

Various types of image forming methods using an electrophotographic technology have been widely known. In this technology, a photoconductive member made of a photoconductive material is charged by various methods using a charging device and then the surface of the charged photoconductive member is illuminated with an optical illuminator to form an electrostatic latent image thereon. Then, the electrostatic latent image is developed with a toner for forming a visible image. And, after transferring the visible toner image onto a transfer medium such as paper or OHP film, the transferred toner image is fixed to the transfer medium by any of various methods such as heating and pressing thereby to obtain a print.

Conventionally, a toner requires excellent image-reproducibility (thin lines and fine points can be accurately reproduced at developing), low-temperature fixability, hot-offset resistance (a toner does not remain on a hot pressing roller, that is a fixing roller, without transferring to a transfer medium) and the like.

Currently, the image forming apparatus is becoming more and more advanced and thus achievement of high speed as well as high resolution by a method of forming an electrostatic latent image by a laser is demanded. Accordingly, in addition to achieving a small particle diameter and a sharp particle diameter distribution for responding to the high resolution requirement, toners require low-temperature fixability so as to correspond with high-printing speed model printers. As a result, it becomes difficult to satisfy both of low-temperature fixability and hot-offset resistance.

For instance, Patent Literature 1 discloses a pulverized toner which contains a binder resin, a colorant and a hydrocarbon wax having a specific relationship between ranges of a hydroxy value and an ester value and an amount. The Patent Literature shows that the toner has excellent low-temperature fixability and hot-offset resistance whereby the toner is not adhered on a fixing roller. However, the toner disclosed in the Patent Literature has a problem in decreasing of shelf stability.

In order to solve such the problems, methods for producing a toner (a polymerized toner) by various types of polymerization methods have been proposed. The polymerized toners have a relatively small particle size distribution and substantially the same charge amount. And, in addition of advantages that fog is hardly occurred, the polymerized toners can contain a low-softening point substance such as a parting agent therein, whereby hot-offset hardly occurs and excellent shelf stability is provided.

For an example of such polymerized toner, Patent Literature 2 discloses a toner producing method in which a charge control resin compound containing a charge control resin, a colorant and an inorganic particles within a specific content range is enveloped in a binder resin. By using the toner disclosed in the Patent Literature, a clear image can be formed and the toner is not changed in a charge amount even leaving the toner under different environments.

Patent Literature 3 discloses a producing method of a polymerized toner, in which a compound containing a polymerizable monomer and the like is polymerized at a previous stage and a subsequent stage, wherein a temperature of each of the stages and a conversion of the monomer into a polymer when the polymerization is transferred to the subsequent stage from the previous stage are defined to a specific range. The toner produced according to the producing method disclosed in the Patent Literature has an excellent balance between a shelf stability, a flowability and a low-temperature fixability, and a hot-offset resistance, thereby providing a high quality image.

However, when the toners disclosed in the Patent Literatures 2 and 3 are used for a high-demand high-printing speed image forming apparatus, such as an apparatus having a printing speed of 24 sheets/minute or more, the balance between a low-temperature fixability and a hot-offset resistance is not always favorable.
Published Patent literature 1: Japanese Patent Application Laid-open 2002-55477,
Published Patent literature 2: Japanese Patent Application Laid-open 2003-131428,
Published Patent literature 3: Japanese Patent Application Laid-open 2002-72565.

### DISCLOSURE OF THE INVENTION

### Problems to be Resolved by the Invention

Accordingly, the object of the present invention is to provide a toner for developing electrostatic latent image, which can be fixed at low temperatures even when the toner is used for a high printing speed apparatus and having an excellent hot-offset resistance.

The inventor of the present invention carried out an in-depth study to accomplish the object. As a result, he has found this object can be accomplished by using a toner for developing electrostatic latent image containing a colored resin particle comprising at least a binder resin, a colorant and a charge control agent, in which the colored resin particle is designed such that a volume average particle diameter and an average circularity are set to a specific range respectively, and also a shear viscosity at a specific share rate is set to a specific range.

The present invention has been accomplished based on the above finding and provide a toner for developing electrostatic latent image comprising a colored resin particle containing a binder resin, a colorant, a charge control agent and a parting agent, having the following properties; (1) said colored resin particle has a volume average particle diameter (Dv) in the range of 4 to 9 μm; (2) said colored resin particle has an average circularity in the range of 0.93 to 0.995; (3) said toner has a shear viscosity (η1) at 130° C. and a shear rate of 10/s in the range of 800 to 3,500 Pa·s; and (4) said toner has a shear viscosity (η2) at 130° C. and a shear rate of 500/s in the range of 100 to 1,000 Pa·s.

### Effect of the Invention

According to the present invention, a toner for developing electrostatic latent image, which can be fixed at low temperatures even when the toner is used for a high-speed printing apparatus and has an excellent durability and shelf stability as well as an excellent hot-offset resistance, can be provided.

### BEST MODE FOR CARRYING OUT THE INVENTION

A toner for developing electrostatic latent image according to the present invention is described in detail below.

A toner for developing electrostatic latent image according to the present invention comprises a colored resin particle containing at least a binder resin, a colorant, a charge control agent and a parting agent.

As the examples of the binder resin, there can be mentioned; resins such as polystyrene, styrene-butyl acrylate copolymers, polyester resins and epoxy resins, which are conventionally used for the toner.

For a black color toner, any pigments and dyes can be employed, in addition to carbon black, titanium black, magnetic powder, oil black and titanium white. Carbon black having a primary particle diameter in the range of 20 to 40 nm is preferably used as a black colorant. The particle diameter within this range is preferred because such carbon black can be uniformly dispersed in the toner for developing electrostatic latent image and fog in printed image developed using the resulting toner decreases.

For a full color toner, a yellow colorant, a magenta colorant and a cyan colorant are generally used.

As the yellow colorant, there can be mentioned; compounds such as azo pigments, and condensed polycyclic, pigments. Specific examples of the yellow colorant include pigments. such as C.I. Pigment Yellow 3, 12, 13, 14, 15, 17, 62, 65, 73, 74, 83, 90, 93, 97, 120, 138, 155, 180, 181, 185 and 186.

As the magenta colorant, there can be mentioned; compounds such as azo pigments, and condensed polycyclic pigments. Specific examples of the magenta colorant include pigments such as C.I. Pigment Red 31, 48, 57, 58, 60, 63, 64, 68, 81, 83, 87, 88, 89, 90, 112, 114, 122, 123, 144, 146, 149, 150, 163, 170, 184, 185, 187, 202, 206, 207, 209, 251, and C.I. Pigment Violet 19.

As the cyan colorant, there can be mentioned; cupper phthalocyanine compounds and their derivatives, anthraquinone compounds and the like. Specific examples of the cyan colorant include pigments such as C.I. Pigment Blue 2, 3, 6, 15, 15:1, 15:2, 15:3, 15:4, 16, 17, and 60.

One or two or more kinds of each of the yellow colorant, the magenta colorant and the cyan colorant maybe used together.

An amount of the colorant is preferably 1 to 10 parts by weight per 100 parts by weight of the binder resin.

As the charge control agent, charge control agents used in conventionally used toners can be employed without limitation. Among the charge control agents, a charge control resin is preferable, because charge control resins have high compatibility with binder resins, are colorless, and can provide a toner with a stable charging property even when it is used in high-speed continuous color printing. As the positive charge control resin, there can be mentioned; quaternary ammonium (salt) group-containing copolymers produced in accordance with the descriptions of U.S. Pat. No. 4,840,863(A), Japanese Patent Application Laid-Open Nos. Hei 3-175456, Hei 3-243954 and Hei11-15192. And, as the negative charge control resin, there can be mentioned; sulfonic acid (salt) group-containing copolymers produced in accordance with the descriptions of U.S. Pat. No. 4,950,575(A) and Japanese Patent Application Laid-Open No. Hei 3-15858.

An amount of the monomer unit having the quaternary ammonium (salt) group or the sulfonic acid (salt) group contained in these copolymers is preferably 1 to 12% by weight, more preferably 1.5 to 8% by weight, to an amount of the charge control resin. If the amount of the monomer unit is within this range, a charge amount of the toner for developing electrostatic latent image is easy to control, and the generation of fog in printed image developed using the toner can be minimized.

Preferred as the charge control resin is that having a weight average molecular weight of 2,000 to 50,000, more preferably 4,000 to 40,000, most preferably 6,000 to 35,000. If the charge control agent has a weight average molecular within the aforesaid range, occurrence of hot-offset and decrease in fixability may be suppressed.

A glass transition temperature of the charge control resin is preferably from 40 to 80° C., more preferably from 45 to 75° C., most preferably from 45 to 70° C. If the glass transition temperature of the charge control resin is within this range, a shelf stability and a fixability may be improved in a balanced manner.

An amount of the charge control agent is generally 0.1 to 10 parts by weight, preferably 0.5 to 6 parts, per 100 parts by weight of the binder resin.

As the parting agent, there can be mentioned; polyolefin waxes such as low molecular weight polyethylene, low molecular weight polypropylene and low molecular weight polybutylene; natural plant waxes such as candelilla, carnauba, rice, wood wax and jojoba; petroleum waxes such as paraffin, microcrystalline and petrolatum, as well as waxes modified therefrom; synthetic waxes such as Fischer-Tropsch wax; and multifunctional ester compounds such as pentaerythritol tetrastearate, pentaerythritol tetrapalmitate and dipentaerythritol hexamyristate.

Among these parting agents, multifunctional ester compounds are preferred. Furthermore, multifunctional ester compounds are more preferred, which show an endothermic peak temperature within the range preferably from 30 to 150° C., more preferably from 40 to 100° C., most preferably from 50 to 80° C., measured with a DSC curve by means of a differential scanning calorimeter at rising temperature, because a toner excellent in a balance between fixing property and peeling property during fixing is obtained. In particular, those having a molecular weight of 1,000 or more and soluble in styrene at 25° C. in amount of 5 parts by weight or more per on 100 parts by weight of styrene, and having a hydroxy value of 5 mg KOH/g or less, are even more preferred, because it exhibits an effect in suppressing occurrence of hot-offset. The hydroxyl value is more preferably 3 mgKOH/g or less, particularly preferably 2 mgKOH/g or less. In addition, the multifunctional ester compounds having an acid value of 0.5 mgKOH/g or less are more preferred because of a remarkable effect for lowering a fixing temperature. The acid value and the hydroxyl value refer to values measured in accordance with JOCS.2.3.1-96 and JOCS.2.3.6.2-96, respectively, which are standards of an oil analysis method established by JAPAN Oil Chemists' Society (JOCS). The endothermic peak temperature refers to values measured in accordance with ASTM D3418-82.

An amount of the parting agent is generally 3 to 20 parts by weight, preferably 5 to 15 parts by weight, per 100 parts by weight of the binder resin.

The colored resin particle maybe a so-called core-shell structured (also called “capsule type”) particle, in which a polymer for an inner layer (a core layer) of the particle is different from a binder resin for an outer layer (a shell layer) of the particle. The core-shell structure is preferred because the type can provide a favorable balance between lowering of the fixing temperature and prevention of aggregation of the toner during shelf by covering the low softening point substance as the inner layer (core layer) with a substance having a higher softening point.

The core layer of the core-shell type particle is composed of the aforementioned binder resin, colorant, charge control resin and parting agent, while the shell layer is composed of the binder resin alone.

A proportion by weight of the core layer to the shell layer of the core-shell type particle is not particularly limited, but is generally in the range of 80/20 to 99.9/0.1.

By using the shell layer in this proportion, good shelf stability and good low temperature fixability of the toner can be fulfilled at the same time.

An average thickness of the shell layer of the core-shell type particle may be generally 0.001 to 0.1 μm, preferably 0.003 to 0.08 μm, more preferably 0.005 to 0.05 μm. The toner having a thickness within the range is preferred because fixability and shelf stability thereof are improved. The colored resin particle of the core-shell type particle does not necessarily have all of its surface covered with the shell layer. The surface of the core particle may partly be covered with the shell layer.

A diameter of the core particle and a thickness of the shell layer of the core-shell type particle can be measured by directly measuring the diameter and thickness of particles which are chosen randomly from photographs taken with an electron microscope, if possible. When it is difficult to observe both of the core and shell layer by an electron microscope, they can be calculated based on the diameter of the core particle and the amount of the monomer used for forming the shell layer at the time of producing the toner.

The colored resin particle constituting a toner for developing electrostatic latent image according to the present invention has preferably a volume average particle diameter (Dv) of 4 to 9 μm, more preferably 4 to 7 μm. If the Dv may be smaller than 4 μm, flowability of the resulting toner for developing electrostatic latent image may lower, resulting in lowering cleaning ability and thus causing fog. On the contrary, if the Dv may be larger than 9 μm, reproducibility of thin lines may be lowered.

The colored resin particles constituting a toner for developing electrostatic latent image according to the present invention preferably has a ratio (Dv/Dp) of the volume average particle diameter (Dv) to a number average particle diameter (Dp) of 1.0 to 1.3, preferably 1.0 to 1.2. If the Dv/Dp is within this range, occurrence of fog maybe suppressed.

The colored resin particle constituting the toner for developing electrostatic latent image according to the present invention has an average circularity from 0.93 to 0.995, preferably from 0.95 to 0.995. The circularity within this range suppresses lowering of reproducibility of thin lines at an N/N environment (a temperature: 23° C., a humidity: 50%).

Producing a toner for developing electrostatic latent image by means of a phase-transfer emulsion process, a solution suspension process, or a polymerization process (suspension polymerization process, emulsion polymerization method) and the like makes it possible to set the average circularity within the range easily.

In the present invention, the circularity is defined as a ratio of a perimeter of a circle having the same projected area as that of the particle image to a perimeter of the projected area of the particle. And, an average circularity in the present invention is used as a conventional method for quantitatively presenting a shape of a particle, and is an index for showing a degree of surface roughness of the colored resin particle. If the colored resin particles are perfectly spherical, the average circularity equals to 1. And, the larger the roughness of the colored resin particle is, the smaller the average circularity is. The average circularity (Ca) is calculated using the following formula.

$$Ca = ( {\sum }_{i = 1}^{n} ( Ci \times fi ) ) / {\sum }_{i = 1}^{n} ( fi )$$

In the above formula, n represents the number of particles used for calculating the circularity Ci.

In the above formula, Ci represents the circularity of each particle in a group of particles having a circle equivalent diameter of 0.6 to 400 μm, which is calculated by the following formula from the measured circuit length of each particle.

Circularity (Ci)=a perimeter length of the circle having the same area with the projected area of a particle/a perimeter length of the projected area of a particle.

In the above formula, fᵢ represent a frequency of particle having circularity Cᵢ.

The number average particle diameter, the volume average particle diameter, the circularity and the average circularity of the colored resin particle may be measured with flow type particle projection image analyzers, such as FPIA-2100 (trade name) or FPIA-2000 (trade name), manufactured by Sysmex Corporation.

The toner for developing electrostatic latent image according to the present invention has a shear viscosity (η1) at a temperature of 130° C. and a shear rate of 10/s of 800 to 3,500 Pa·s, preferably 1,000 to 3,000 Pa·s. If η1 is smaller than 800 Pa·s, hot-offset may occur easily and a shelf stability may deteriorate. On the contrary, if η1 is larger than 3,500 Pa·s, a low-temperature fixability may decrease.

And, the toner for developing electrostatic latent image according to the present invention has a shear viscosity (η2) at a temperature of 130° C. and a shear rate of 500/s of 100 to 1,000 Pa·s, preferably 300 to 800 Pa·s. If η2 is smaller than 100 Pa·s, hot-offset may occur easily. On the contrary, if η1 is larger than 1,000 Pa·s, a low-temperature fixability may decrease.

Besides, the toner for developing electrostatic latent image according to the present invention preferably has a ratio (η1/η2) of η1 to η2 of 3 to 10, more preferably 4 to 8.

The toner having η1/η2 within the aforesaid range is preferred because decrease in a low-temperature fixability and occurrence of hot-offset are suppressed.

The shear viscosity can be measured using a capillary rheometer in accordance with JISK7199. Using a twin capillary rheometer of the capillary rheometer is preferable because of easy measurement of a shear viscosity. A conventionally used capillary rheometer is equipped with a long capillary die. However, since such a capillary rheometer causes pressure loss at measurement, it is necessary to compensate for the loss. Therefore, in order to obtain correct rheologic properties of a substance, a measurement using a capillary rheometer equipped with a short capillary die under the same condition is required. Using a twin capillary rheometer enables the measurement at once. As such a twin capillary rheometer, “RH7” (Trade Name) manufactured by ROSAND and the like can be employed.

In the toner for developing electrostatic latent image according to the present invention, an amount of insoluble component in tetrahydrofran is preferably 10 to 70% by weight, more preferably 20 to 65% by weight. An amount of insoluble component in tetrahydrofran within the range is preferred because a low-temperature fixability can be improved.

The amount of insoluble component in tetrahydrofran can be measured using an after-mentioned method.

For the toner for developing electrostatic latent image according to the present invention, a colored resin particle can be used, as it is, for development in electrophotography. Generally, however, it is preferable that the toner is used after fine particles having a smaller particle diameter than that of the colored resin particles (the fine particles will be referred to hereinafter as an external additive) are adhered to or buried into the surfaces of the colored resin particles, in order to adjust the charging properties, flowability and shelf stability of the toner.

Examples of the external additive are inorganic particles and organic resin particles which are used for improving flowability and charging ability. The particles added as the external additive has an average particle diameter smaller than the colored resin particle. Specific examples of the inorganic particles include silica, aluminum oxide, titanium oxide, zinc oxide, tin oxide and the like. Specific examples of the organic resin particles include methacrylic ester polymer particles, acrylic ester polymer particles, styrene-methacrylic ester copolymer particles, styrene-acrylic ester copolymer particles, core-shell structured particles having a core formed of a styrene polymer and a shell formed of a methacrylic ester polymer. Of these particles, particles of silica and titanium oxide are preferred. In addition, the inorganic fine particle is preferably subjected to a hydrophobicitizing treatment. In fact, a hydrophobicitizing-treated silica is preferred. An amount of the external additive is not limited; however, is generally 0.1 to 6 parts by weight per 100 parts by weight of the colored resin particle.

The colored resin particle constituting a toner for developing electrostatic latent image according to the present invention may be produced by any methods for producing a toner having the aforesaid properties; however, not limited to, the colored resin particle is preferably produced by a polymerization method, especially a suspension polymerization method.

Next, a method for producing the colored resin particles by the polymerization method will be described.

The colored resin particle constituting a toner for developing electrostatic latent image according to the present invention is produced such that a colorant, a charge control agent, a parting agent, a chain transfer agent and other additives are dissolved or dispersed in a polymerizable monomer (comprising a monovinyl monomer, a crosslinkable monomer and the like) which is a raw material of the binder resin, the mixture to which a polymerization initiator is added is polymerized in an aqueous dispersing medium containing a dispersion stabilizer and then subjected to a filtration, washing, dehydration and drying. At the polymerization, a kind and an amount ratio of the polymerizable monomer, a kind of an amount of the crosslinkable monomer, an amount of the chain transfer agent and a kind and an amount of the parting agent are controlled so that shear viscosities η1 and η2 and the like can be set to the specified ranges.

Alternatively, the colored resin particle constituting a toner for developing electrostatic latent image according to the present invention is obtained in the following manner. A polymerizable monomer which is a raw material of the binder resin, a chain transfer agent and other additives are emulsion polemerized in an aqueous dispersing medium containing a emulsifying agent and then a colorant, a charge control agent and a parting agent are emulsified. And, the emulsified components are aggregated by heat to obtain a dispersion of the colored resin particles. Then, the dispersion of the colored resin particles is subjected to afiltration, washing, dehydration and drying. At the polymerization, a kind and an amount ratio of each of the polymerizable monomer and the crosslinkable monomer, an amount of the chain transfer agent and a kind and an amount of the parting agent are controlled so that shear viscosities η1 and η2 and the like can be set to the specified ranges.

As a polymerizable monomer, there can be mentioned, for instance, a monovinyl monomer, a crosslinkable monomer and a macromonomer. These polymerizable monomers become the binder resin component after polymerization.

Specific examples of the monovinyl monomers include; aromatic vinyl monomers such as styrene, vinyltoluene and α-methylstyrene; acrylic ester monomers such as acrylic acid, methyl acrylate, ethyl acrylate, propyl acrylate, butyl acrulate, 2-ethylhexyl acrylate, cyclohexyl acrylate and isobonyl acrylylate; methacrylic ester monomers such as methacrylic acid, methyl methacrylate, ethyl methacrylate, propyl methacrylate, butyl methacrylate, 2-ethlhexyl methacrylate, cyclohexyl methacrylate and isobonyl methacrylylate; and mono olefin monomers such as ethylene, propylene and butylenes; and the like.

The monovinyl monomers may be used alone or in a combination thereof. Among the monovinyl monomers as mentioned above, it is preferable to use aromatic vinyl monomers alone, or to use aromatic vinyl monomers in a combination with acrylic ester monomers or methacrylic ester monomers.

The use of the crosslinkable monomer in a combination with the monovinyl monomer effectively improves hot offset resistance of the resulting toner. The crosslinkable monomer is a monomer having two or more vinyl groups. As specific examples of the crosslinkable monomer, there can be mentioned; polypropylene based diacrylate, 1,9-nonandiol diacrylate, propylene oxide adduct diacrylate of bisphenol A, divinylbenzene, divinylnaphthalene, ethlenglycol dimethacrylate, pentaerythritol triallyl ether and, trimethylolpropane triacrylate. Among the crosslinkable monomers, polypropylene based diacrylate, 1,9-nonandiol diacrylate, propylene oxide adduct diacrylate of bisphenol A, which are bifunctional crosslinkable monomers having a large molecular weight, are preferred. These crosslinkable monomers may be used alone or in a combination thereof. In this case, it is preferred to use at least one of the bifunctional monomers having a large molecular weight. In addition, a total addition amount of the bifunctional crosslinkable monomers is 50% by weight or more to a total addition amount of the crosslinkable monomers. An amount of the crosslinkable monomer is generally 10 parts by weight or less, preferably 0.1 to 2 parts by weight, per 100 parts by weight of the monovinyl monomer.

It is preferable to use a macromonomer together with the monovinyl monomer because this use provides a satisfactory balance between shelf stability and fixability at a low temperature. The macromonomer is an oligomer or polymer having a polymerizable carbon-carbon unsaturated double bond at its molecular chain terminal and a number average molecular weight of generally from 1,000 to 30,000.

The macromonomer is preferably the one which gives a polymer having a glass transition temperature higher than that of a polymer obtained by polymerizing the above-mentioned monovinyl monomer alone.

An amount of the macromonomer used is generally 0.01 to 10 parts by weight, preferably 0.03 to 5 parts by weight, more preferably 0.05 to 1 part by weight, per 100 parts by weight of the monovinyl monomer.

As examples of the polymerization initiator, there can be mentioned; persulfates such as potassium persulfate and ammonium persulfate; azo compounds such as 4,4′-azobis-(4-cyanovaleric acid), 2,2′-azobis-(2-methyl-N-(2-hydroxyethyl))propionamide, 2,2′-azobis-(2-amidinopropane)dihydrochloride, 2,2′-azobis-(2,4-dimethyl valeronitrile) and 2,2′-azobis-isobutyronitrile; and peroxides such as di-t-butyl peroxide, benzoyl peroxide, t-butyl peroxy-2-ethylhexanoate, t-hexyl peroxy-2-ethylhexanoate, t-butyl peroxypivalate, di-isopropyl peroxydicarbonate, di-t-butyl peroxyisophthalate, and t-butyl peroxyisobutyrate. Redox initiators, composed of combinations of these polymerization initiators with a reducing agent, may also be used.

An amount of the polymerization initiator used in the polymerization of the polymerizable monomer is preferably 0.1 to 20 parts by weight, more preferably 0.3 to 15 parts by weight, most preferably 0.5 to 10 parts by weight, per 100 parts by weight of the polymerizable monomer. The polymerization initiator may be added to the polymerizable monomer composition in advance or may be added to an aqueous dispersion medium after forming droplets depending on conditions.

Moreover, at the time of polymerization, a dispersion stabilizer may be added to the aqueous dispersing medium. As the dispersion stabilizer, there can be mentioned; an inorganic salt such as barium sulfate, calcium sulfate, calcium carbonate, magnesium carbonate and calcium phosphate; an inorganic oxide such as aluminum oxide and titanium oxide; an inorganic compound such as aluminium hydroxide, magnesium hydroxide and ferric hydroxide; a water-soluble polymers such as polyvinyl alcohol, methyl cellulose and gelatin; anionic surfactants; nonionic surfactants; and amphoteric surfactants. The aforesaid dispersion stabilizer may be used alone or in combination of two kinds thereof.

Among the above dispersion stabilizers, a dispersion stabilizer containing colloid of the metallic compound, especially a hardly water-soluble inorganic hydroxide, is preferred, since it can narrow the particle size distribution of a polymer particles; the remaining amount of the dispersion stabilizer after washing is small; and it can sharply reproduce images.

An amount of the above dispersion stabilizer is preferably 0.1 to 20 parts by weight per 100 parts by weight of the polymerizable monomer. The amount of the dispersion stabilizer within this range is preferred because the polymerization reaction is stably performed and a formation, of polymerization aggregate is suppressed.

Further, upon polymerization, a molecular weight modifier is preferably used. As the molecular weight modifier, there can be mentioned; mercaptans such as t-dodecyl mercaptan, n-dodecyl mercaptan, n-octyl mercaptan and 2,2,4,6,6-pentamethylheptane-4-thiol and the like. The molecular weight modifier may be added before or during polymerization reaction. An amount of the molecular weight modifier is preferably 0.01 to 10 parts by weight, more preferably 0.1 to 5 parts by weight, per 100 parts by weight of the polymerizable monomer.

A method for producing the core-shell type colored resin particles is not limited, and these colored resin particles can be produced by a publicly known method. For example, a method such as spray-drying method, interfacial reaction method, in-situ polymerization method, or phase separation method may be named. Specifically, colored resin particles obtained by pulverization, polymerization, association or phase inversion emulsification as core particles are covered with a shell layer to prepare core-shell type colored resin particles. Of these methods, the in-situ polymerization method and phase-separation method are preferable because of their efficient productivity.

The method for producing the core-shell type colored resin particles using the in-situ polymerization process is described below.

A polymerizable monomer to form a shell (a polymerizable monomer for shell) and a polymerization initiator are added to an aqueous dispersion medium including core particles dispersed therein, and the mixture is polymerized to obtain the core-shell type colored resin particles.

As specific examples of the process for forming the shell, there can be mentioned; a process comprising adding a polymerizable monomer for a shell to a reaction system of a polymerization reaction which has been conducted for preparing core particles to continuously conduct polymerization; and a process comprising introducing core particles prepared in a different reaction system and adding a polymerizable monomer for a shell thereto to conduct polymerization.

The polymerizable monomer for shell may be added to the reaction system at one time, or may be added continuously or dividedly using a pump such as a plunger pump.

As the polymerizable monomer for shell, monomers capable of forming a polymer having a glass transition temperature of higher than 80° C. by polymerization, such as styrene, acrylonitrile and methyl methacrylate, may be used alone or in a combination thereof.

When the polymerizable monomer for shell is added to the reaction system, a water-soluble polymerization initiator as a polymerization initiator for polymerizing the polymerizable monomer for shell is preferably added, because this addition makes it easy to obtain the core-shell type colored particles. It is speculated that when the water-soluble polymerization initiator is added during addition of the polymerizable monomer for shell, the water-soluble polymerization initiator migrates to a zone surrounding the surface of the core particle, the zone where the polymerizable monomer for shell has moved, so that a polymer (shell) is easily formable on the surface of the core particle.

As the water-soluble polymerization initiator; there can be mentioned; persulfates such as potassium persulfate, and ammonium persulfate; azo compounds such as 2,2′-azobis-(2-methyl-N-(2-hydroxyethyl)propionamide), and 2,2′-azobis-(2-methyl-N-(1,1′-bis(hydroxymethyl)-2-hydro xyethyl)propionamide. An amount of the water-soluble polymerization initiator is generally 0.1 to 30 parts by weight, preferably 1 to 20 parts by weight, per 100 parts by weight of the polymerizable monomer for shell.

A temperature during the polymerization is preferably 50° C. or higher, more preferably 60 to 95° C. A polymerization reaction period is preferably 1 to 20 hours, more preferably 2 to 10 hours. After completion of the polymerization, a procedure comprising filtration, washing, dehydration and drying is preferably repeated several times, as desired, in accordance with the conventional methods.

In the aqueous dispersion of the colored resin particles obtained by the polymerization, if an inorganic compound such as inorganic hydroxide is used as the dispersion stabilizer, the dispersion stabilizer is preferably dissolved in water and removed by adding acid or alkali. If a colloid of a hardly water-soluble inorganic hydroxide is used as the dispersion stabilizer, it is preferable to add acid so that pH of the aqueous dispersion is pH 6.5 or lower. As the acid to be added, an inorganic acid such as sulfuric acid, hydrochloric acid or nitric acid; or an organic acid such as formic acid or acetic acid; can be used. Sulfuric acid is particularly preferable because it has a high efficiency of its removal and its burden on production facilities is light.

There is no limitation on the method of filtering colored resin particles from the aqueous dispersion medium for dehydration. For example, centrifugal filtration, vacuum filtration or pressurized filtration can be named. Of these methods, centrifugal filtration is preferable.

The toner for developing electrostatic latent image according to the present invention is obtained by mixing the colored resin particles and the external additive and, if desired, other fine particles by means of a high-speed stirrer such as a Henschel mixer.

### EXAMPLE

The present invention is hereinafter to be described more specifically by the following examples. Such examples, however, are not to be construed as limiting in any way the scope of the present invention. All designations of “part” or “parts” and “%” used in the following examples mean part or parts by weight and wt. % unless expressly noted.

In this example, a toner for developing electrostatic latent image is evaluated using the following methods.

1. Property of Colored Resin Particle

(1) Volume Average Particle Diameter, Particle Size Distribution and Average Circularity

100 μl of an aqueous solution of 0.1% sodium dodecylbenzenesulfonate (an anion surface activator) as a dispersion medium was added to 20 mg of a toner for developing electrostatic latent image and blended with the toner. And, 10 ml of ion-exchanged water was added to the toner mixture and stirred, and then the mixture was dispersed using an ultrasonic dispersion apparatus of 60 W for 30 minutes. A toner concentration at a measurement was adjusted to 3,000 to 10,000/μl and then 1,000 to 10,000 of the toner particle having a circle equivalent diameter of 1 μm or more were evaluated using “FPIA-2100” (trade name), manufactured by Sysmex Corporation. From the measurement, avolume average particle diameter (Dv), a particle diameter distribution, i.e., a ratio (Dv/Dp) of the volume average particle diameter to a number average particle diameter (Dp), and an average circularity were obtained.

(2) Amount of Insoluble Component in Tetrahydrofuran.

About 1 g of the toner for developing electrostatic latent image was weighed and charged into a Soxhlet extractor equipped with a cylindrical filter (No. 86R, 29×100 mm, manufactured by Toyo Roshi Kaisha, Ltd.). Then, the toner was refluxed with about 100 ml of tetrahydrofuran (THF) as a solvent for 6 hours. The reflux was carried out at a rate in which one droplet of the solvent was dropped every 5 to 15 minutes. After completion of the reflux, the cylindrical filter was air-dried in a draft for one night and further dried under reduced pressure at 50° C. for 1 hour, and then weighed. Then, an amount of insoluble component in tetrahydrofran was measured using the following expression.
An amount of insoluble component in tetrahydrofran (% by weight)=(S/T)×100.

In the expression, T represents an amount (g) of the toner for developing electrostatic latent image and S represents an amount (g) of the insoluble component remaining on the filter after the reflux.

(3) Shear Viscosity

A shear viscosity was evaluated in accordance with JIS K7199. A toner for developing electrostatic latent image weighed about 30 g was charged into a barrel and heated to melt the toner for developing electrostatic latent image while deaerating, and then maintained at 130° C. for 10 minutes. Then, the toner was evaluated by means of a capillary rheometer (RH7, trade name, manufactured by ROSAND) under the following condition. The obtained data was subjected to a correction (Bagley correction) of a pressure loss caused by the capillary die and Rabinovich correction using an analysis software (Dr. Rheology Ver. 7, manufactured by ITS JAPAN Co., Ltd.) to obtain a graph showing a shear viscosity. From the graph, shear viscosities η1 and η2 at shear rates of 10/s and 500/s, respectively, were obtained.

Measurement Condition:

a diameter of the barrel: 15 mm;
a length of the barrel: 280 mm;
a material of the capillary die: tungsten carbide;
a capillary die: a diameter of 1 mm, a length of 16 mm, an inflow angle of 180° and a diameter of 1 mm, a length of 0 mm, an inflow angle of 180°; and
a measurement mode: twin capiro mode, Bagley correction ON, Rabinovich correction: ON.
   2. Property of Toner
   (4) Durability.

Copy papers were set in a 600 dpi high-printing speed non-magnetic-one-component developing type printer (30-sheet/min machine), and the toner was put in a developing device of the printer. The printer was laid still for a day and a night under an (N/N) environment of a temperature of 23° C. and a humidity of 50%. Under the environment, a line image of 2×2 dot line (a line width of about 85 μm) was continuously printed. And, at every 500 papers printing, the printed image was evaluated in such a way that any 10 lines of the printed line image were evaluated for density curve using aprint quality evaluation system (“RT2000”, trade name, manufactured by YA-MAN Inc.) and then a width at half height of a peak of the density curve of each lines was calculated. And, the widths of the lines were averaged to obtain a line width w2. Then, on the basis of the line width w1 of the first printed line image, a number of printed papers capable of having a line width of w1±10 μm was examined until 10,000 papers printing.

(5) Fixing Temperature

A fixing test was conducted using the printer used in (4) modified such that the temperature of its fixing roll portion would be variable. The fixing test was performed by varying the temperature of the fixing roll of the modified printer by 5° C. at a time, and measuring the fixing rate of the developer at each temperature to determine a relationship between a temperature and a fixing rate. The fixing rate was calculated from the ratio of image density after a tape peeling treatment to that before the treatment in a black solid printing area in a test sheet printed by the modified printer. That is, the fixing rate was calculated from the following equation:
Fixing rate (%)=(ID_{After}/ID_{Before})×100
where ID_{Before} represents the image density before tape peeling, and ID_{After} represents the image density after tape peeling.

The tape peeling treatment means a series of steps consisting: applying an adhesive tape (Scotch Mending Tape 810-3-18, trade name, manufactured by Sumitomo 3M Limited) to a portion of the test sheet to be evaluated, pressing the adhesive tape at a constant pressure, and then peeling the adhesive tape at a constant speed in a direction along the sheet. The image density was measured by use of a Macbeth's reflection type image density measuring device. The toner fixing temperature denotes the temperature of the fixing roll at which the fixing rate became 80% in the fixing test. A toner having a lower fixing temperature is superior because the toner has a low-temperature fixability and thus can be used in a high-printing speed model printer.

(6) Hot-Offset Temperature

As in the measurement of the toner fixing temperature in test (5), the temperature of the fixing roll was varied by 5° C. at a time, and printing was done at each temperature. Hot-offset resistance denotes the temperature at which the toner becomes to remain on the fixing roll to generate soil. A toner having a higher hot-offset temperature is superior because the toner has a hot-offset resistance and thus can be used in a high-printing speed model printer.

(7) Shelf Stability

The toner for developing electrostatic latent image was charged into a sealable container and then sealed. And, the container was sunk in a constant-temperature bath of a temperature of 55° C. and allowed to stand for 8 hours. After 8 hours, the container was get out the bath and the toner for developing electrostatic latent image was transferred onto a 42 mesh sieve from the container. In this procedure, the toner was taken out of the container so as not to destroy the aggregate structure of the toner and carefully transferred to the sieve. The sieve on which the toner was transferred was vibrated with the use of a powder measuring device (“POWDER TESTER PT-R”, trade name, manufactured by Hosokawa Micron Corporation) under a condition of a vibration amplitude of 1.0 mm for 30 seconds. Then, the weight of the toner remaining on the sieve was measured, and the measured value was taken as a weight of the aggregated toner. The proportion of the weight (wt. %) of the aggregated toner to a weight of the toner initially placed in the container was calculated. The measurement was made three times for one sample, and the average of the measured values was obtained and used as an index of shelf stability. The shelf stability of the toner is better as it shows a smaller value (wt. %).

### Example 1

100 parts of monomer composition comprising 80.5 parts of styrene and 19.5 parts of n-butylacrylate, 0.5 parts of polyisoprene based diacrylate (an average molecular weight: 3,000, “BAC-45”, trade name, manufactured by OSAKA ORGANIC CHENUCAL INDUSTRY LYD.), which was a crosslinkable monomer, 6 parts of carbon black (“#25”, trade name, manufactured by Mitsubishi Chemical Corporation), 1 parts of negative charge control resin (containing 2% of sulfonic acid functional group, “FCA S748”, trade name, manufactured by FUJIKURA KASEI CO., LTD.), 2 parts of t-dodecyl mercaptan and 0.5 parts of polymethacrylate ester macromonomer (“AA6”, trade name, Tg: 94° C., manufactured by Toagosei CO., LTD.) were stirred and mixed by means of a conventionally used stirrer, and then uniformly dispersed by means of a media type dispersing apparatus. After that, 10 parts of dipentaerythritol hexamyristate (an acid value: 0.5 mgKOH/g, a hydroxy value: 1.2 mgKOH/g) was added and mixed to the mixture. And, the mixture was dissolved to obtain a polymerizable monomer composition (compound liquid). The preparations of the polymerizable monomer composition were performed under a room temperature (about 23° C.).

Under a room temperature, an aqueous solution containing 6.6 parts of sodium hydroxide dissolved in 50 parts of ion-exchanged water was gradually added to an aqueous solution containing 10.8 parts of magnesium chloride dissolved in 250 parts of ion-exchanged water, with stirring, to prepare a magnesium hydroxide colloidal dispersion. The preparations of the dispersion were performed under a room temperature.

Separately, 2 parts of methyl methacrylate and 65 parts of water were mixed to obtain an aqueous dispersion of polymerizable monomer for shell.

The polymerizable monomer composition obtained above was added to the colloidal dispersion of magnesium hydroxide obtained above at a room temperature, and the mixture was stirred until droplets stabilized. After the droplets stabilized, 5 parts of t-butyl peroxy-2-ethylhexanoete (“PERBUTYL O”, trade name, manufactured by NOF CORPORATION), which was a polymerization initiator, was added to the mixture, and then the mixture was stirred at 15,000 rpm under shearing force using a Ebara Milder (“MDN303V”, trade name, manufactured by Ebara Corporation) to form droplets of the polymerizable monomer composition.

The colloidal dispersion of magnesium hydroxide in which the droplets of the polymerizable monomer composition are dispersed was charged into a reactor equipped with an agitating blade, and heated to 90° C. to initiate a polymerization reaction. At the time when the conversion of the monomer into a polymer reached almost 100%, to the aqueous dispersion of the polymerizable monomer for shell, 0.2 parts of water-soluble polymerization initiator (“VA-086”, trade name, manufactured by Wako Pure Chemical Industries, Ltd.,) (2,2′-azobis-(2-methyl-N-(2-hydroxyethyl))propionamide) was dissolved, and then the aqueous dispersion was charged into the reactor. The polymerization reaction was continued for 10 hours under a temperature controlled at 90° C. After the polymerization reaction, the dispersion was cooled to obtain an aqueous dispersion of colored resin particles. While stirring the aqueous dispersion of colored resin particles thus prepared at a room temperature, the pH of the system was adjusted to 5.5 using sulfuric acid to be subjected to acid washing (25° C., 10 minutes). After the aqueous dispersion was filtered to separate water, 500 parts of ion-exchanged water was newly added thereto to form a slurry again to subject to water washing. Thereafter, the dehydration and water washing were repeatedly performed several times at a room temperature, and solids contained in the solution was separated by filtration and dried at 45° C. for one day and night using a dryer to prepare dried colored resin particles. The colored resin particles thus obtained had a volume average particle diameter (Dv) of 6.4 μm, aparticle diameter distribution (Dv/Dp) of 1.17 and a circularity of 0.970.

To 100 parts of the colored resin particles obtained above, 0.6 parts of hydrophobicitizing-treated colloidal silica (“RX-200”, trade name, manufactured by Nippon Aerosil co., ltd.) was added and mixed for 10 minutes at 1,400 rpm using HENSCHEL MIXER to obtain toner for developing electrostatic latent image. Property of the toner for developing electrostatic latent image and image quality of a printed image developed using the toner for developing electrostatic latent image were evaluated according to the above-mentioned manner. The results were shown in table 1.

### Example 2

In the same way as in Example 1, except that a monomer composition comprising 90 parts of styrene and 10 parts of n-butylacrylate was employed, an amount of polyisoprene based diacrylate was changed to 1.5 parts and an amount of t-dodecyl mercaptan was changed to 1 part, toner for developing electrostatic latent image was obtained. Property of the toner for developing electrostatic latent image, and image quality of a printed image developed using the toner for developing electrostatic latent image were evaluated as with Example 1. The results were shown in table 1.

### Example 3

In the same way in Example 1, except that a monomer composition comprising 90 parts of styrene and 10 parts of n-butylacrylate was employed, polyisoprene based diacrylate was changed to 2 parts of propylene oxide adduct diacrylate of bisphenol A (“LIGHTACRYLATE BR-4PA”, trade name, manufactured by Kyoei kagaku Kogyo Co., Ltd.) and an amount of t-dodecyl mercaptan was changed to 0.6 parts, toner for developing electrostatic latent image was obtained. Property of the toner for developing electrostatic latent image, and image quality of a printed image developed using the toner for developing electrostatic latent image were evaluated as with Example 1. The results were shown in table 1.

### Comparative Example 1

100 parts of monomer composition comprising 80.5 parts of styrene and 19.5 parts of n-butylacrylate, 6 parts of carbon black (“#25”, trade name, manufactured by Mitsubishi Chemical Corporation), 1 part of charge control agent (“Spilon Black TRH”, trade name, manufactured by HODOGAYA CHEMICAL CO., LTD.), 0.4 parts of divinylbenzene and 0.5 parts of polymethacrylate ester macromonomer (“AA6”, Trade Name, Tg: 94° C., manufactured by Toagosei CO., LTD.) were stirred and mixed by means of a conventionally used stirrer, and then uniformly dispersed by means of a media type dispersing apparatus. Then, 10 parts of dipentaerythritol hexalaurate (an acid value: 0.5 mgKOH/g, a hydroxy value: 5.1 mgKOH/g) was added and mixed to the mixture. And, the mixture was dissolved to obtain a polymerizable monomer composition. The preparations of the polymerizable monomer composition were performed under a room temperature (about 23° C.).

Then, in the same manner as Example 1, toner for developing electrostatic latent image was obtained. Property of the toner for developing electrostatic latent image, and image quality of a printed image developed using the toner for developing electrostatic latent image were evaluated as with Example 1. The results were shown in table 1.

### Comparative Example 2

90 parts of styrene to which 10 parts of parting agent (“FT-100”, trade name, manufactured by NIPPON SEIRO CO.,Ltd.) was added was wet-milled using a bead mill so as to have an average diameter of 2 μm. 67 parts of styrene, 15 parts of n-butylacrylate, 0.3 parts of divinylbenzene, 1 parts of t-dodecyl mercaptan, 20 parts of the styrene solution of the parting agent (comprising 18 parts of styrene and 2 parts of parting agent) produced by the wet milling, 7 parts of carbon black (“#25”, trade name, manufactured by Mitsubishi Chemical Corporation), 1 parts of charge control agent (“Spilon Black TRH”, trade name, manufactured by HODOGAYA CHEMICAL CO., LTD.) were dispersed by a bead mill at a room temperature to prepare a polymerizable monomer composition.

An aqueous solution containing 6.9 parts of sodium hydroxide dissolved in 50 parts of ion-exchanged water was gradually added to an aqueous solution containing 9.8 parts of magnesium chloride dissolved in 250 parts of ion-exchanged water, with stirring, to prepare a magnesium hydroxide colloidal dispersion.

The polymerizable monomer composition obtained above was added to the colloidal dispersion of magnesium hydroxide obtained above, and the mixture was stirred to form droplets of the polymerizable monomer composition. The aqueous dispersion was charged into a reactor equipped with an agitating blade, and heated in such a way that a heating rate was controlled at about 50° C./hour from a room temperature to 80° C. and then the temperature was maintained at 80° C. At the time when the conversion of the monomer into a polymer reached 40%, the heating was restarted in such a way that an average heating rate was controlled at 40° C./hour up to 95° C. and then the temperature was maintained at 95° C. In order to accomplish such temperature history, the temperature of the aqueous dispersion was controlled such that a temperature of a jacket of the reactor and a temperature of the polymerization reaction liquid were measured and the temperature of the jacket was controlled by a cascade regulation and the like. After the temperature of the aqueous dispersion was reached 95° C., the temperature was changed between 94° C. to 97° C. After the polymerization reaction, the aqueous dispersion was cooled to prepare an aqueous dispersion of colored resin particles.

While stirring the aqueous dispersion of colored resin particles thus prepared, the pH of the system was adjusted to 5.5 using sulfuric acid to be subjected to acid washing (25° C., 10 minutes). After the aqueous dispersion was filtered to separate water, 500 parts of ion-exchanged water was newly added thereto to form a slurry again to subject to water washing. Thereafter, the dehydration and water washing were repeatedly performed several times at room temperatures, and solids contained in the solution was separated by filtration and dried at 45° C. for two days and nights using a dryer to prepare dried colored resin particles.

To 100 parts of the colored resin particles obtained above, 0.6 parts of hydrophobicitizing-treated colloidal silica (“RX-200”, trade name, manufactured by Nippon Aerosil co., ltd.) was added and mixed for 10 minutes at 1,400 rpm using HENSCHEL MIXER to prepare toner for developing electrostatic latent image. Property of the toner for developing electrostatic latent image, and image quality of a printed image developed using the toner for developing electrostatic latent image were evaluated according to the above-mentioned manner. The results were shown in table 2.

TABLE 1

| | Example 1 | Example 2 | Example 3 |
|---|---|---|---|
| <Property of Colored Resin Particle> | | | |
| Volume Average particle diameter | 6.4 | 6.5 | 6.8 |
| (μm) | | | |
| Particle diameter distribution (Dv/Dp) | 1.18 | 1.19 | 1.20 |
| Average circularity | 0.970 | 0.965 | 0.965 |
| <Property of Toner> | | | |
| Shear viscosity η1 (Pa · s) | 1400 | 2300 | 2900 |
| Shear viscosity η2 (Pa · s) | 310 | 500 | 700 |
| η1/η2 | 4.52 | 4.60 | 4.14 |
| Amount of insoluble component in | 37 | 48 | 65 |
| THF (wt %) | | | |
| <Evaluation of Printed Image> | | | |
| Durability (sheet) | 9000 | 9000 | 9000 |
| Fixing temperature (° C.) | 145 | 145 | 150 |
| Hot-offset temperature (° C.) | 200 | 200 | 200 |
| Shelf stability (wt %) | 5 | 5 | 5 |

TABLE 2

| | Comparative | Comparative |
|---|---|---|
| | Example 1 | Example 2 |
| <Property of Colored Resin Particle> | | |
| Volume Average particle diameter (μm) | 6.2 | 7.3 |
| Particle diameter distribution (Dv/Dp) | 1.18 | 1.21 |
| Average circularity | 0.970 | 0.980 |
| <Property of Toner> | | |
| Shear viscosity η1 (Pa · s) | 5000 | 7000 |
| Shear viscosity η2 (Pa · s) | 1110 | 1800 |
| η1/η2 | 4.55 | 3.89 |
| Amount of insoluble component in THF | 72 | 33 |
| (wt %) | | |
| <Evaluation of Printed Image> | | |
| Durability (sheet) | 9000 | 8000 |
| Fixing temperature (° C.) | 155 | 155 |
| Hot-offset temperature (° C.) | 190 | 185 |
| Shelf stability (wt %) | 11 | 15 |

The results of the evaluation of the toner for developing electrostatic latent image shown in the tables 1 and 2 show the following facts.

The toners of the Comparative Example 1 to 2, in which shear viscosities η1 and η2 of the toner for developing electrostatic latent image were outside of the scope of the present invention, shows less durability and shelf stability, high fixing temperature and easy occurrence of hot-offset.

On the contrary, the toners of the Examples 1 to 3, according to the present invention show good durability and shelf stability, and can be fixed at a low-temperature. In addition, by using the toners, hot-offset hardly occurs.

What is claimed is:

1. A toner for developing electrostatic latent image comprising a colored resin particle containing a binder resin, a colorant, a charge control agent and a parting agent, having the following properties;
(1) said colored resin particle has a volume average particle diameter (Dv) in the range of 4 to 9 μm;
(2) said colored resin particle has an average circularity in the range of 0.93 to 0.995;
(3) said toner has a shear viscosity (η1) at 130° C. and a shear rate of 10/s in the range of 800 to 3,500 Pa·s; and
(4) said toner has a shear viscosity (η2) at 130° C. and a shear rate of 500/s in the range of 100 to 1,000 Pa·s.

2. The toner for developing electrostatic latent image according to claim 1,
wherein a ratio of η1 to η2 (η1/η2) is 3 to 10.

3. The toner for developing electrostatic latent image according to claim 1,
wherein an amount of insoluble component in tetrahydrofran is 10 to 70% by weight.

4. The toner for developing electrostatic latent image according to claim 1,
wherein said charge control agent is a charge control resin.

5. The toner for developing electrostatic latent image according to claim 4,
wherein said charge control resin has a glass transition temperature in the range of 40 to 80° C.

6. The toner for developing electrostatic latent image according to claim 1,
wherein said parting agent is a multifunctional ester compound having a hydroxyl value of 5 mgKOH/g or less.

7. The toner for developing electrostatic latent image according to claim 1,
wherein said parting agent is a multifunctional ester compound having an acid value of 0.5 mgKOH/g or less.

8. The toner for developing electrostatic latent image according to claim 1,
wherein said parting agent is a multifunctional ester compound having a molecular weight of 1000 or more.

9. The toner for developing electrostatic latent image according to claim 1,
wherein said parting agent is a multifunctional ester compound soluble in 100 parts by weight of styrene at 25° C. in an amount of 5 parts by weight or more.

10. The toner for developing electrostatic latent image according to claim 1,
wherein said colored resin particle has an average circularity in the range of 0.95 to 0.995.

11. The toner for developing electrostatic latent image according to claim 1,
wherein said colored resin particle has a volume average particle diameter (Dv) in the range of 4 to 7 μm.

12. The toner for developing electrostatic latent image according to claim 1,
wherein said colored resin particle has a ratio (Dv/Dp) of a volume average particle diameter (Dv) to a number average particle diameter (Dp) in the range of 1.0 to 1.3.

13. The toner for developing electrostatic latent image according to claim 1,
wherein said binder resin is a polymer produced by a polymerization of a polymerizable monomer containing monovinylmonomer and crosslinkable monomer, in which said crosslinkable monomer is selected from the group consisting of polyisoprene based diacrylate, 1,9-nonandiol diacrylate and propylene oxide adduct diacrylate of bisphenol A.

14. The toner for developing electrostatic latent image according to claim 13,
where in an addition amount of said cross linkable monomer is 10 parts by weight or less to 100 parts by weight of said monovinyl monomer.

15. The toner for developing electrostatic latent image according to claim 13,
wherein a molecular weight modifier is employed at said polymerization, in which an addition amount of said molecular weight modifier is 0.1 to 5 parts by weight per 100 parts by weight of said colored resin particle.

16. The toner for developing electrostatic latent image according to claim 1 further comprising an external additive,
wherein a content of the external additive is 0.1 to 6 parts per 100 parts by weight of the colored resin particle.

17. The toner for developing electrostatic latent image according to claim 16,
wherein said external additive is a hydrophobicitizing-treated particle.

18. The toner for developing electrostatic latent image according to claim 16,
wherein said external additive is a hydrophobicitizing-treated silica particle.

19. The toner for developing electrostatic latent image according to claim 1,
wherein said colored resin particle is produced by a polymerization reaction.
